(19) United States
(12) Patent Application Publication
(10) Pub. No.: US 2013/0239054 A1
(43) Pub. Date: Sep. 12, 2013

(54) Method And Device Of Operation Menu Display Control For Analyzer

(71) Applicants: Hirofumi Toshima, Hitachinaka (JP); Masato Ito, Hitachinaka (JP)

(72) Inventors: Hirofumi Toshima, Hitachinaka (JP); Masato Ito, Hitachinaka (JP)

(73) Assignee: Hitachi High-Technologies Corporation, Minato-ku, Tokyo (JP)

(21) Appl. No.: 13/881,766

(22) PCT Filed: Nov. 1, 2011
(86) PCT No.: PCT/JP2011/075132

§ 371 Date: May 30, 2013

(30) Foreign Application Priority Data
Nov. 25, 2010 (JP) 2010-262834

(51) Int. Cl. G06F 3/0482

(52) U.S. Cl. CPC G06F 3/0482
USPC 715/811

(57) ABSTRACT

An operation menu display control method for an analyzer is provided which can change the ranking of operation menus to be displayed preferentially in accordance with the frequency of their use by users and which can set operation menus that can be displayed preferentially regardless of the frequency of their use. A storage unit stores a usage count 23 of each of the used operation menus and a usage count ranking 24 with regard to each of the roles played by the users such as a system administrator 20 and an operator 21. Based on the roles of the users who use the analyzer, the method causes a display unit to display the highest-ranked “n” operation menus in terms of usage count stored with regard to each user. The operation menus to be displayed on a display means regardless of the frequency of their use are registered beforehand in a registered/unregistered region 25. The registered operation menus are displayed preferentially on a display device regardless of the frequency of their use.

### TECHNICAL FIELD

The present invention relates to an operation menu display control method and an operation menu display control device for analyzers that measure samples to acquire data and analyze the acquired data to obtain results.

### BACKGROUND ART

A personal computer is frequently utilized as a data processing device for use with analyzers such as liquid chromatography systems and gas chromatography equipment. A data processing program installed in that personal computer is used to control the analyzer and to acquire and analyze data thereby.

In recent years, data processing devices have not only performed analyzer control, data collection and analysis but also incorporated diverse functions such as those for preparing reports and managing data. With this trend have come numerous operation menus getting displayed on an operation screen. Generally, the sequence in which operation menus are displayed and the way they are arranged on the screen are all fixed.

In these circumstances, there is no problem if users are fully cognizant of the arrangement of operation menus being displayed on the screen. If not cognizant of the display arrangement of such operation menus, the users can waste much time in searching for a specific operation menu desired to be used.

Also, some operation menus are frequently used while others are rarely utilized depending on the nature of the user's work. When these operation menus are displayed in mixed fashion, the users can be further burdened with the problem of how to handle them.

Means for solving these problems have been proposed (e.g., see Patent Document 1) whereby operation menus are rearranged in descending order of their usage count when displayed, with the most frequently used operation menu preferentially displayed at the top of a displayed menu hierarchy.

Also, methods have been proposed (e.g., see Patent Document 2) whereby operation menus are displayed not only in rearranged fashion but also in such a manner that infrequently used operation menus are displayed on hierarchical levels different from those of the ordinary menu display.

### PRIOR ART DOCUMENTS

### Patent Documents

Patent Document 1: JP-11-53155-A
Patent Document 2: JP-9-128189-A

### SUMMARY OF INVENTION

### Problem to be Solved by the Invention

The method of having all operation menus rearranged depending on their usage count, as per the above prior art, is effective for general application software that is installed in personal computers for use.

However, the above method is not necessarily effective for analyzers.

That is, in the case of analyzers, a plurality of users each playing a different role of work use the same equipment. These users may use significantly different operation menus depending on the roles they play.

Also, in recent years, operation menus have been arranged in a deeply hierarchical manner. The operation menu desired to be used can thus be reached only after a plurality of operations have been carried out.

An object of the present invention is to realize an operation menu display control method and an operation menu display control device capable of changing the order in which operation menus are displayed preferentially depending on their usage count.

### Means for Solving the Problems

In order to solve the above problems, the present invention is configured as follows:

An operation menu display control method according to the present invention is a method for displaying a plurality of operation menus of an analyzer on display means. A motion control unit of the analyzer makes a storage means to store a usage count of each of the plurality of operation menus and a ranking of the plurality of operation menus in order of usage count with regard to each of a plurality of operating roles played by an operator operating the analyzer, making the display means to display the operation menus successively in descending order of usage count starting from the highest-ranked operation menu with regard to the input operating role in order of the usage count ranking stored in the storage means in accordance with the operating role of the operator input through an input means.

Further, an operation menu display control device of the present invention includes an operation input means which allows an operator operating the analyzer to input operations, a storage means which stores a usage count of each of the operation menus and a ranking of the operation menus in terms of usage count with regard to each of a plurality of operating roles based on operation role information input through the input operation means, and a motion control means which, in accordance with the operating role of the operator input through the input means, causes the display means to display the operation menus successively in descending order of usage count starting from the highest-ranked operation menu with regard to the input operating role in accordance with the usage count ranking stored in the storage means.

### Effects of the Invention

According to the present invention, it is possible to realize an operation menu display control method and an operation menu display control device capable of changing the ranking of operation menus to be displayed preferentially in accordance with the frequency of their use by users who handle an analyzer used in conjunction with the method or device.

### BRIEF DESCRIPTION OF THE DRAWINGS

FIG. 1 is a general block diagram of a liquid chromatography system to which one embodiment of the present invention is applied.

FIG. 2 is a schematic view showing an initial screen of a data processing device as one embodiment of the present invention.

FIG. 3 is a schematic view showing a main screen of the data processing device as one embodiment of the present invention.

FIG. 4 is a diagram showing an operation menu usage count management information table of the data processing device as one embodiment of the present invention.

FIG. 5 is a motion flowchart of the data processing device as one embodiment of the present invention.

FIG. 6 is a motion function block diagram of the data processing device as one embodiment of the present invention.

FIG. 7 is a schematic view showing a main screen in effect when a shortcut is selected on the data processing device as one embodiment of the present invention.

FIG. 8 is a schematic view showing a typical display screen for making preferential registrations with one embodiment of the present invention.

### MODE FOR CARRYING OUT THE INVENTION

Some embodiments of the present invention will be explained below in reference to the accompanying drawings.

### Embodiments

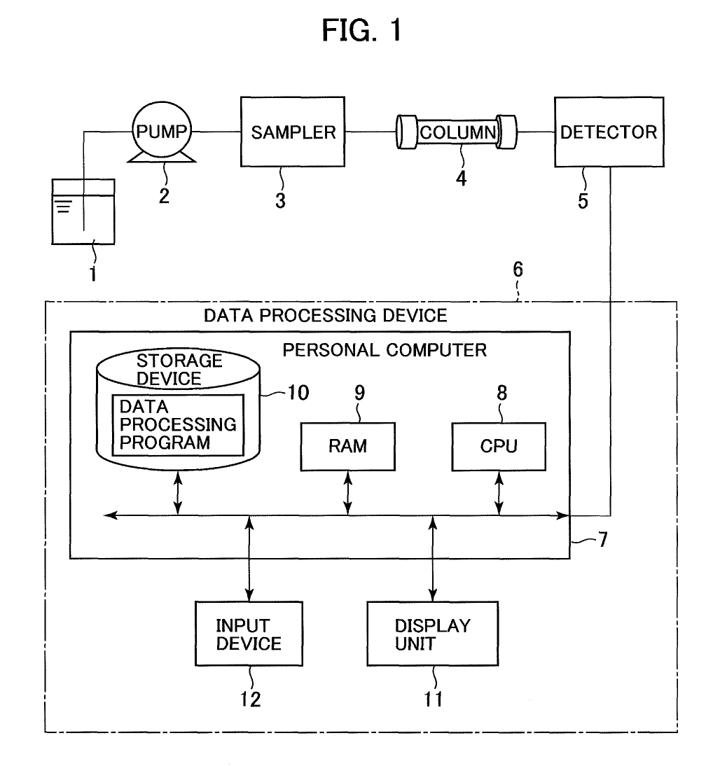

FIG. 1 is an overall block diagram of a liquid chromatography system to which one embodiment of the present invention is applied.

In FIG. 1, an eluant 1 is forwarded by a pump 2 to flow through a sampler 3, a separation column 4 and a detector 5, in that order. A measurement sample is injected by the sampler 3 into the flow of the eluant 1, the flow being separated into components by the column 4.

The sample separated by the column 4 is detected by the detector 5 which in turn sends a detection signal to a data processing device 6.

Generally, a personal computer 7 is used as the data processing device 6. The personal computer 7 includes a CPU 8 that processes data, a RAM 9 that serves as a storage area for temporarily storing data, and a storage device (storage unit) 10 that serves as a data storage area. A display unit 11 such as a liquid crystal monitor and an input device 12 such as a keyboard and a mouse are connected to the personal computer 7.

A data processing program is installed in the storage device 10. In response to the operations performed by the user operating the input device 12 such as the mouse or keyboard, the data processing program causes the display unit 11 to display screens associated with the operations.

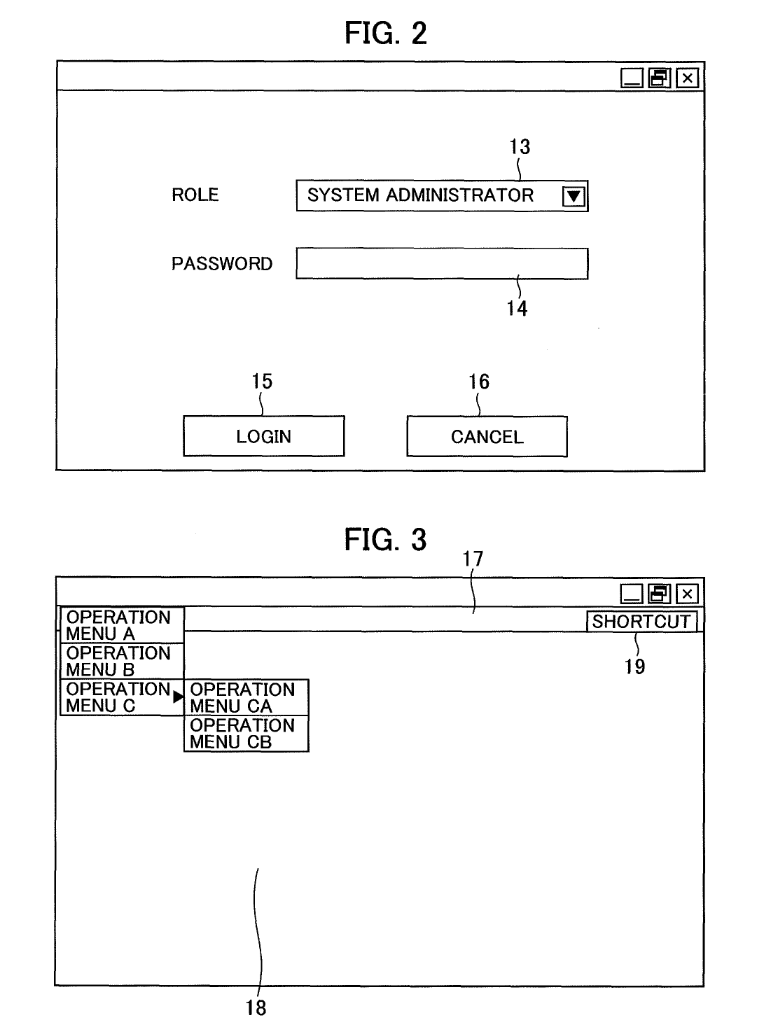

First, the user starts the data processing program held in the storage device 10 by means of the input device 12. With the data processing program started, an initial screen shown in FIG. 2 is displayed on the display unit 11.

Operating the input device 12, the user selects his or her role from a list box 13 on the initial screen and inputs to an input box 14 a password set for the role in question.

The user's major roles include a system administrator, an analytical procedure (method) developer, and an operator. The input of the password is requested here for the purpose of reinforcing security; the input of the password is not mandatory.

Thereafter, pressing a login button 15 starts the main screen of the data processing device 6. Pressing a cancel button 16 cancels the main screen and terminates the data processing program.

FIG. 3 shows a typical main screen displayed on the display unit 11 of the data processing device 6. In FIG. 3, an area 17 is a tool bar in which operation menus are placed.

A display area 18 displays a screen for setting analytical parameters such as analysis conditions, a screen for displaying a chromatogram, and a screen for displaying status of devices connected to the data processing apparatus such as the flow rate of the eluant.

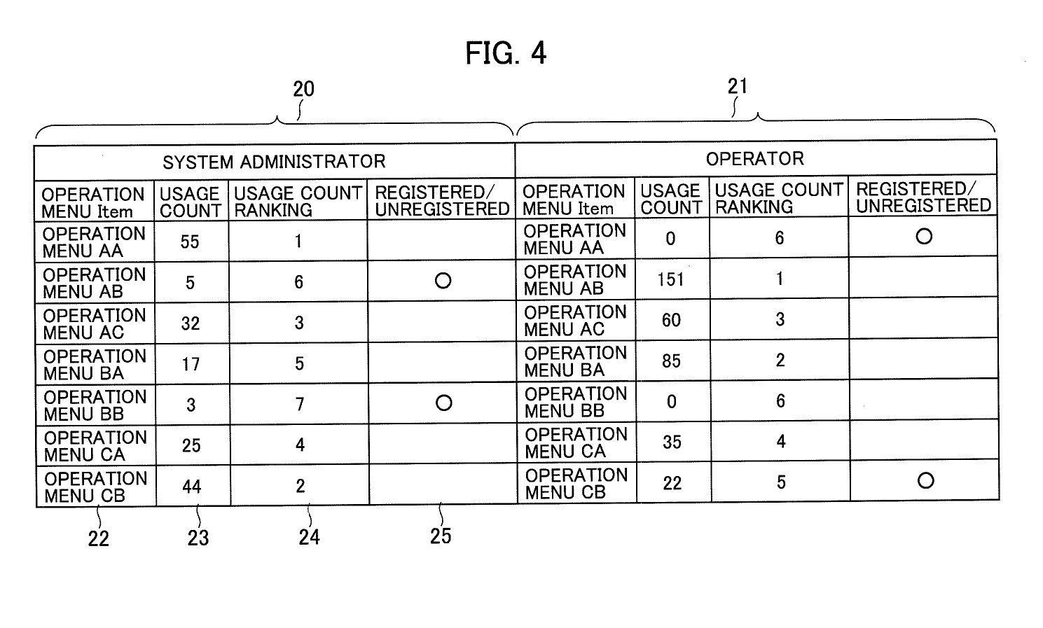

Every time an operation menu is selected in the display area 17, the data processing device 6 records the usage count of the selected operation menu to the storage device 10. The usage count is recorded in a management table such as one shown in FIG. 4, with regard to each role of the user who logged in.

A usage count 23 and a ranking 24 in terms of usage count are managed with regard to each of the operation menus 22 for each role, such as a user's role 20 (system administrator) or a user's role 21 (operator) shown in FIG. 4.

Also the presence and absence of registrations of the operation menus are managed, the operation menus being desired to be displayed preferentially regardless of usage count. An operation menu desired to be displayed preferentially is registered by resorting to a dedicated registration screen or by dragging the operation menu of interest into a designated area or the like to put a marking in a registered/unregistered column 25 (a circle is placed here for registration).

The management table shown in FIG. 4 can also be displayed on the display unit 11.

Typical operation menus include a waveform processing setting menu, a concentration table setting menu, a data file opening file, a method file opening menu, and an electronic approval menu. There also exist operation menus that need to be displayed preferentially regardless of usage count.

For example, a user who carries out the routine work of data collection and analysis repeatedly performs the duties designated for an administrator ranging from the collection and analysis of data to the reporting of analysis results. For this reason, the operation menus usually used by that user are limited.

However, there may be a rare case in which the result of the measurement is different from what is usually expected. For example, impurities may be found contained in the measured sample.

In such a case, within a framework stipulated for the administrator of the data processing device 6, it is necessary to change the conditions for analyzing data in preparing the result as well as the content of the report on the data analysis. In carrying out these changes that are different from the routine work, the user may not be fully cognizant of the arrangement of relevant operation menus and the procedure for handling them.

Also, since the operations involved are not part of the usual ones, the operation menus for making the changes are located on low levels of an operation menu hierarchy based on the method of changing the arrangement of operation menus in accordance with their usage counts. Thus it may take a long time for the user to search for and reach the relevant operation menus, which can be an extra burden on the user.

The administrator of the data processing device 6 has the major duties of managing the user (operator) information and user rights registered with the device 6 and inspecting the device 6. The major operations performed by the administrator are those of verifying the data processing device 6 in use and the status of device use by the user.

But when the users who use the data processing device 6 are changed, as in a personnel reshuffle, the registered user information needs to be changed. This operation is not an ordinarily performed one. As such, the operation is not located on a high level in the operation menu hierarchy as with the above-mentioned operation of changing the users who perform routine work. As a result, it may take a long time for the user to search for and reach the relevant operation menus.

As explained above, the operation menus for use by users differ significantly from one role to another of the user handling the analyzer. It is thus important that the preferential ranking of operation menus should be changed with regard to each role and that the operation menus that can be placed preferentially on high levels in the hierarchy regardless of their usage counts should be set.

Thus one embodiment of the present invention permits registration of the operation menus to be displayed preferentially regardless of the frequency of their use.

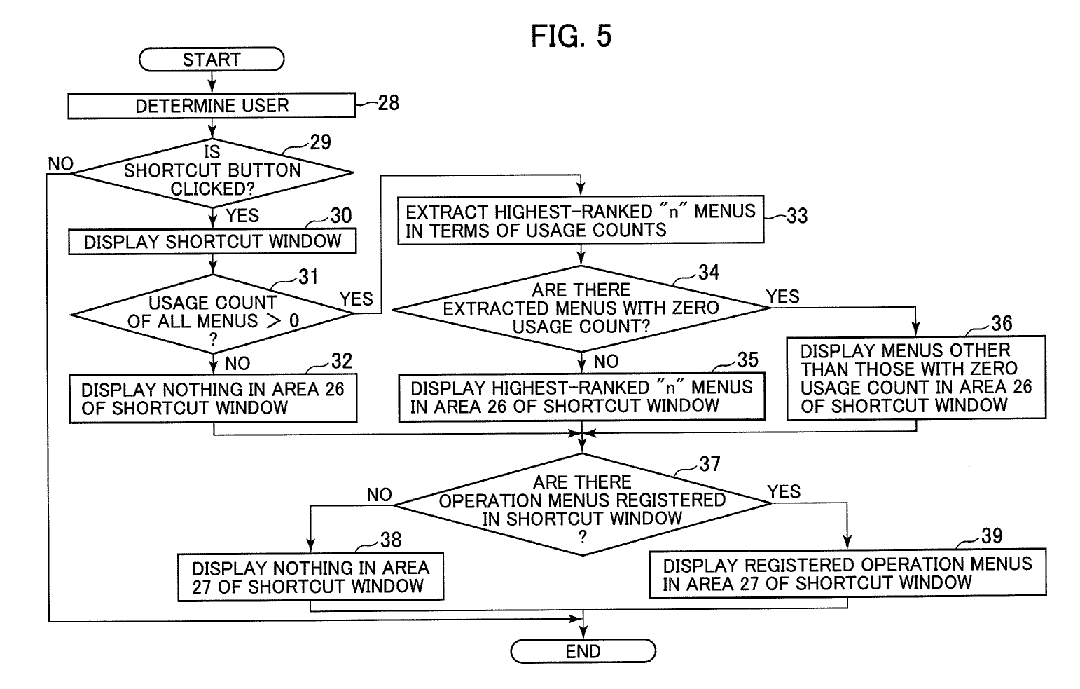

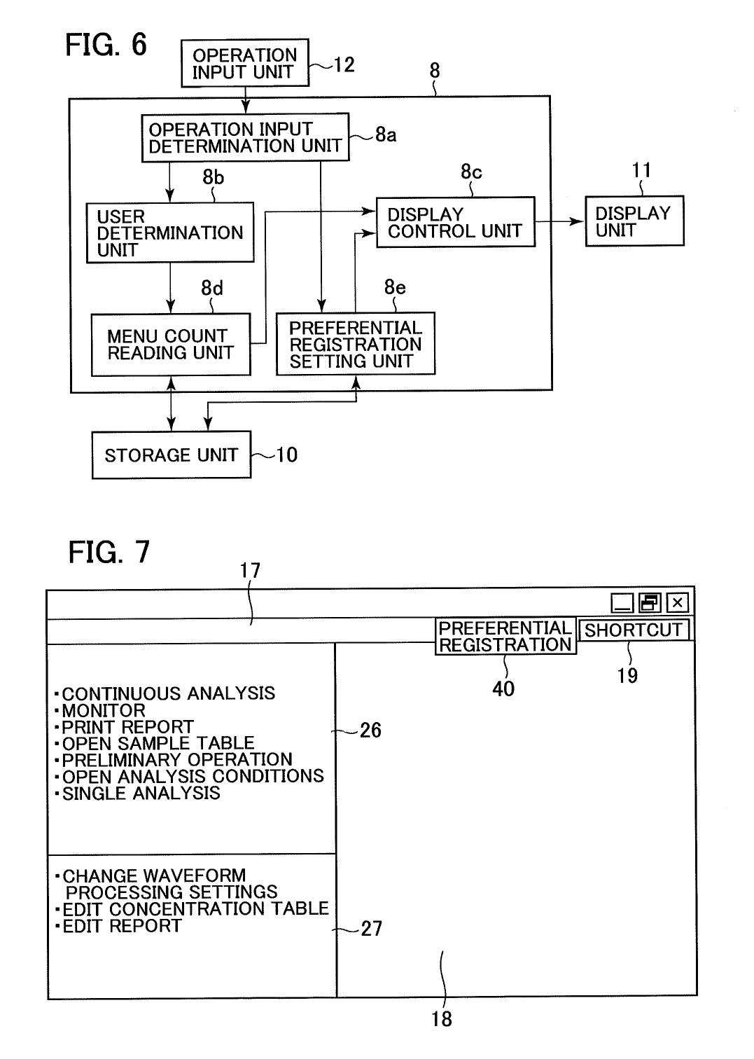

FIG. 5 is a motion flowchart of one embodiment of the present invention. FIG. 6 is a motion function block diagram of the CPU 8. In FIG. 6, the CPU 8 includes as function blocks an operation input determination unit 8a, a user determination unit 8b, a display control unit 8c, a menu count reading unit 8d, and a preferential registration setting unit 8e.

In the motion flowchart of FIG. 5, the role of the user who logs in from the initial screen shown in FIG. 2 is first determined (step 28). It is then determined whether the user has given an instruction to place operation menus into a dedicated area (step 29).

In the example shown in FIG. 5, whether or not the user has given the instruction is determined by verifying whether a shortcut button 19 in FIG. 3 is pressed. The determination is made by the operation input determination unit 8a and user determination unit 8b.

FIG. 7 shows a typical display format in effect when the instruction is given to place operation menus into dedicated areas, i.e., when the shortcut button 19 on the main screen is pressed. When the shortcut button 19 shown in FIG. 3 is pressed, dedicated display areas 26 and 27 appear on the left-hand side of the main screen in FIG. 7 (step 30). These dedicated areas are called the shortcut window hereunder.

After this, it is determined whether the usage count of all operation menus statistically collected for the role of the user currently logging in is larger than zero, i.e., whether any one of these operation menus has been used at least once. The determination is made by the menu count reading unit 8d verifying information about the operation menu usage counts recorded in an operation menu usage count management information table (FIG. 4) stored in the storage unit 10 with regard to each role of the user (step 31).

If the usage count is zero, i.e., if none of the operation menus has been used yet (this is the first time to use), then no operation menu is displayed (placed) in the area 26 of the shortcut window in FIG. 7, and the next process 37 is reached.

If the usage count is larger than zero, then the highest-ranked “n” operation menus in terms of the usage counts statistically collected for the login user are extracted (step 33).

The user may designate the “n” operation menus. For example, when the shortcut button 19 is pressed, a screen asking the user the desired number of the highest-ranked operation menus to be displayed in the shortcut window is displayed prompting the user to make the settings. The number that has been set here is “n.”

It is then verified whether there exists an operation menu with zero usage count among the extracted operation menus (step 34). If there is no operation menu with zero usage count, the menu count reading unit 8d instructs the display control unit 8c to extract the highest-ranked “n” operation menus from the storage unit 10 and display the extracted menus in the area 26 of the shortcut window (step 35).

If in step 34 there are found operation menus with zero usage count, the menu count reading unit 8d instructs the display control unit 8c to display the operation menus other than the those with zero usage count in the area 26 of the shortcut window (step 36).

Next, the menu count reading unit 8d queries the storage unit 10 to see if there exist registered operation menus to be display preferentially regardless of the usage counts registered earlier (step 37). If there is no preferentially registered operation menu, the processing is terminated with nothing displayed in the area 27 of the shortcut window (step 38).

If the preferentially registered operation menus are found in step 37, the preferential operation menu processes (i.e., operation menus each with a circle marked in the registered/unregistered column of FIG. 4) registered in the area 27 of the shortcut window are displayed (step 39).

FIG. 7 shows the state in effect after the above processes have been completed. The area 26 in the shortcut window displays the designated number of operation menus in descending order of their usage counts corresponding to the role of the user currently logging in. The area 27 displays the user-registered operation menus regardless of their usage counts. When any of the operation menus displayed in the shortcut window is selected, the same processing as that of an operation menu in the ordinary tool bar is carried out.

The operation menus displayed in the shortcut window are recorded to and retained in the storage unit 10 until the shortcut button 19 is pressed the next time. The information is recorded here for each role of the user, so that the operation menus are stored in a manner suitable for the role of the login user.

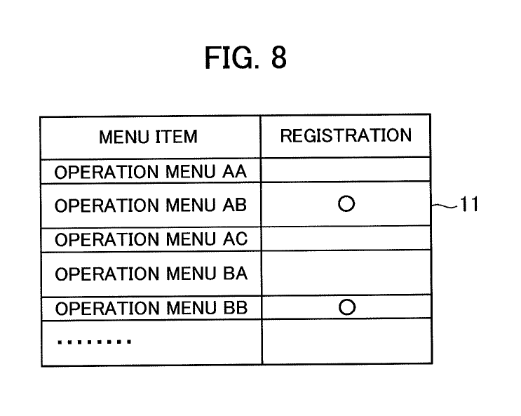

A method for setting preferential registrations is explained here. When the user presses a shortcut window preferential registration button 40 shown in FIG. 7, the operation input determination unit 8a determines that the button is pressed. The preferential registration setting unit reads preferential registration information from the storage unit 10 and instructs the display control unit 8c to display the registration information shown in FIG. 8 on the display unit 11.

And the user operates the input device 12 to put a check (circle) to the operation menus desired to be displayed preferentially and have these menus stored into the storage unit 10. The storing of the menus into the storage unit 10 is performed by the preferential registration setting unit 8e in accordance with the instructions supplied via the operation input unit 12 and operation input determination unit 8a.

The menu count reading unit takes menu usage counts with regard to each user, determines the ranking of the usage counts taken and the ranking of operation menus in terms of their usage counts, and stores these settings into the storage unit 10.

As explained above, according to one embodiment of the present invention, the shortcut window displays the frequently used operation menus and the designated operation menus with regard to each role of the user. Also, if there exist the operation menus to be displayed preferentially regardless of the frequency of their use, these menus can be set for preferential display. This makes it possible for an analytical instrument for use by users of different roles to be handled with enhanced ease of use for each role played by each user.

That is, it is possible to implement an operation menu display control method and an operation menu display control device whereby the user handling the analyzer can change the preferential display ranking of operation menus in accordance with the frequency of their use and can also set the operation menus that will be displayed preferentially regardless of their frequency of use.

### DESCRIPTION OF REFERENCE NUMERALS

1 Eluant
2 Pump
3 Sampler
4 Separation column
5 Detector
6 Data processing device
7 Personal computer
8 CPU
8a Operation input determination unit
8b User determination unit
8c Display control unit
8d Menu count reading unit
8e Preferential registration setting unit
9 RAM
10 Storage device (storage unit)
11 Display unit
12 Input device
13 List box
14 Password input box
15 Login button
16 Cancel button
17 Tool bar
18 Display area
19 Shortcut button
20, 21 Display of user's role
22 Operation menu
23 Usage count
24 Usage count ranking
25 Registered/unregistered indication
26, 27 Shortcut window area
40 Preferential registration button

1. An operation menu display control method for an analyzer having a display means for displaying a plurality of operation menus,
wherein an analyzer motion control unit causes a storage means to store therein a usage count of each of the plurality of operation menus and a ranking of the plurality of operation menus in order of usage count with regard to each of a plurality of operating roles played by an operator operating the analyzer, and
wherein given the operating role of the operator input through an input means, the analyzer motion control unit causes the display means to display the operation menus successively in descending order of usage count starting from the highest-ranked operation menu with regard to the input operating role in accordance with the usage count ranking stored in the storage means.

2. The operation menu display control method for an analyzer according to claim 1,
wherein the motion control unit causes the display means to display as many operation menus as a display count designated by the operator through the input means, successively in descending order of usage count in accordance with the usage count ranking starting from the highest-ranked operation menu.

3. The operation menu display control method for an analyzer according to claim 1,
wherein the motion control unit causes the storage means to store those operation menus to be displayed preferentially out of the plurality of operation menus regardless of usage count with regard to each operating role of the operator, and the motion control unit further causes the display means to display preferentially those operation menus to be displayed preferentially in accordance with the operating role of the operator.

4. The operation menu display control method for an analyzer according to claim 1,
wherein the motion control unit excludes those operation menus having a zero usage count from the operation menus targeted to be displayed on the display means, out of the operation menus stored in the storage means with regard to each operating role of the operator.

5. The operation menu display control method for an analyzer according to claim 1,
wherein the analyzer is a liquid chromatographic system.

6. An operation menu display control device for an analyzer having a display means for displaying a plurality of operation menus, the operation menu display control device comprising:
an operation input means which allows an operator operating the analyzer to input operations;
storage means which stores a usage count of each of the operation menus and a ranking of the operation menus in terms of usage count with regard to each of a plurality of operating roles based on operation role information input through the input operation means, and
motion control means which, in accordance with the operating role of the operator input through the input means, causes the display means to display the operation menus successively in descending order of usage count starting from the highest-ranked operation menu with regard to the input operating role in accordance with the usage count ranking stored in the storage means.

7. The operation menu display control device for an analyzer according to claim 6,
wherein the motion control unit causes the display means to display as many operation menus as a display count designated by the operator through the input means, successively in descending order of usage count in accordance with the usage count ranking starting from the highest-ranked operation menu.

8. The operation menu display control device for an analyzer according to claim 6,
wherein the motion control unit causes the storage means to store those operation menus to be displayed preferentially out of the plurality of operation menus regardless of usage count with regard to each operating role of the operator, and the motion control unit further causes the display means to display preferentially those operation menus to be displayed preferentially in accordance with the operating role of the operator.

9. The operation menu display control device for an analyzer according to claim 6,
wherein the motion control unit excludes those operation menus having a zero usage count from the operation menus targeted to be displayed on the display means, out of the operation menus stored in the storage means with regard to each operating role of the operator.

10. The operation menu display control device for an analyzer according to claim 6,
wherein the analyzer is a liquid chromatographic system.
